(19) United States
(12) Patent Application Publication
(10) Pub. No.: US 2006/0203162 A1
(43) Pub. Date: Sep. 14, 2006

(54) Liquid crystal display device

(76) Inventors: Hideki Ito, Saitama-shi (JP); Akio Murayama, Fukaya-shi (JP); Yuuzo Hisatake, Fukaya-shi (JP); Chigusa Tago, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/367,338

(22) Filed: Mar. 6, 2006

(30) Foreign Application Priority Data
Mar. 8, 2005 (JP) 2005-064128

(51) Int. Cl. G02F 1/1335

(52) U.S. Cl. 349/117

(57) ABSTRACT

A circular-polarization-based vertical alignment mode liquid crystal display device includes a circular polarizer structure, a variable retarder structure and a circular analyzer structure. The circular polarizer structure includes a first optical compensation layer for optical compensation thereof, the first optical compensation layer including a uniaxial retardation plate with a refractive index anisotropy of nx≈ny<nz. The circular analyzer structure includes a second optical compensation layer for optical compensation thereof, the second optical compensation layer including a uniaxial retardation plate with a refractive index anisotropy of nx≈ny<nz. The variable retarder structure includes a third optical compensation layer for optical compensation thereof, the third optical compensation layer including a uniaxial retardation plate with a refractive index anisotropy of nx≈ny>nz.

### CROSS-REFERENCE TO RELATED APPLICATIONS

This application is based upon and claims the benefit of priority from prior Japanese Patent Application No. 2005-064128, filed Mar. 8, 2005, the entire contents of which are incorporated herein by reference.

### BACKGROUND OF THE INVENTION

1. Field of the Invention

The present invention relates generally to a liquid crystal display device, and more particularly to a circular-polarization-based vertical-alignment-mode liquid crystal display device.

2. Description of the Related Art

A liquid crystal display device has various features such as thickness in size, light weight, and low power consumption. The liquid crystal display device is applied to various uses, e.g. OA equipment, information terminals, timepieces, and TVs. In particular, a liquid crystal display device comprising thin-film transistors (TFTs) has high responsivity and, therefore, it is used as a monitor of a mobile TV, a computer, etc., which displays a great deal of information.

In recent years, with an increase in quantity of information, there has been a strong demand for higher image definition and higher display speed. Of these, the higher image definition is realized, for example, by making finer the array structure of the TFTs. On the other hand, in order to increase the display speed, consideration has been given to a VAN (Vertically Aligned Nematic) mode.

The VAN mode has a higher response speed than in a conventional TN (Twisted Nematic) mode. An additional feature of the VAN mode is that a rubbing process, which may lead to a defect such as an electrostatic breakage, can be made needless by vertical alignment. Particular attention is drawn to a multi-domain VAN mode (hereinafter referred to as “MVA mode”) in which a viewing angle can be increased relatively easily.

The MVA mode is realized by controlling the inclination of an electric field which is applied between a pixel electrode and a counter-electrode. A pixel region includes, e.g. four domains such that the orientation directions of liquid crystal molecules are substantially uniform in a voltage-on state. This realizes improvement in symmetry of viewing angle characteristics and suppression of an inversion phenomenon.

In addition, a negative retardation plate is used to compensate the viewing angle dependency of the normal-directional phase difference of the liquid crystal layer in the state in which the liquid crystal molecules are aligned substantially vertical to the major surface of the substrate, that is, in the state of black display. Thereby, the contrast (CR) that depends on the viewing angle is improved. Besides, more excellent viewing angle vs. contrast characteristics can be realized in the case where the negative retardation plate is a biaxial retardation plate having such an in-plane phase difference as to compensate the viewing angle dependency of the polarizer plate.

In the conventional MVA mode, however, since each pixel has a plurality of domains in a voltage-on state, a region, where liquid crystals are oriented in a direction other than a desirable direction, is formed. For example, liquid crystals are schlieren-oriented or orientated in an unintentional direction, at a boundary of the divided domains, at a protrusion that is a structural element for forming the multi-domain structure, or near a slit.

In a linear-polarization-based, birefringence-controlled liquid crystal display device, such a problem arises that transmittance is lowered in a region where liquid crystal molecules are oriented in a direction other than a desirable direction.

In order to overcome this problem, a circular-polarization-based MVA mode has currently been considered. The above problem is solved by replacing the linear polarizer plate with a circular polarizer plate, which has a retardation plate, that is, a uniaxial ¼ wavelength plate that provides a phase difference of a ¼ wavelength between light rays of predetermined wavelengths that travel along the fast axis and slow axis. In the circular-polarization-based, birefringence-controlled liquid crystal display device, the transmittance does not depend on the direction of alignment of liquid crystal molecules. Thus, even if there is a region where liquid crystal molecules are oriented in a direction other than a desirable direction, a desired transmittance can be obtained if the tilt of the liquid crystal molecules is controlled.

In the prior-art circular-polarization-based MVA mode, however, there is such a problem that the viewing angle characteristic range is narrow.

### BRIEF SUMMARY OF THE INVENTION

The present invention has been made in consideration of the above-described problems, and the object of the invention is to provide a liquid crystal display device that can improve viewing angle characteristics and can reduce cost.

According to a first aspect of the invention, there is provided a liquid crystal display device which is configured such that a dot-matrix liquid crystal cell, in which a liquid crystal layer is held between two electrode-equipped substrates, is disposed between a first polarizer plate that is situated on a light source side and a second polarizer plate that is situated on an observer side, a first retardation plate is disposed between the first polarizer plate and the liquid crystal cell, and a second retardation plate is disposed between the second polarizer plate and the liquid crystal cell, the liquid crystal display device comprising: a circular polarizer structure including the first polarizer plate and the first retardation plate; a variable retarder structure including the liquid crystal cell; and a circular analyzer structure including the second polarizer plate and the second retardation plate, wherein the variable retarder structure has an optically positive normal-directional phase difference in a black display state, each of the first retardation plate and the second retardation plate is a uniaxial ¼ wavelength plate which provides a phase difference of a ¼ wavelength between light rays of predetermined wavelengths that travel along a fast axis and a slow axis thereof, the circular polarizer structure includes a first optical compensation layer which is disposed for optical compensation of the circular polarizer structure between the first polarizer plate and the first retardation plate, the first optical compensation layer including a uniaxial third retardation plate with a refractive index anisotropy of nx≈ny<nz, the circular analyzer structure includes a second optical compensation layer which is disposed for optical compensation of the circular analyzer structure between the second polarizer plate and the second retardation plate, the second optical compensation layer including a uniaxial fourth retardation plate with a refractive index anisotropy of nx≈ny<nz, and the variable retarder structure includes a third optical compensation layer which is disposed for optical compensation of the variable retarder structure between the first retardation plate and the second retardation plate, the third optical compensation layer including a uniaxial fifth retardation plate with a refractive index anisotropy of nx≈ny>nz.

According to a second aspect of the invention, there is provided a liquid crystal display device which is configured such that a first retardation plate is disposed between a dot-matrix liquid crystal cell, in which a liquid crystal layer is held between two electrode-equipped substrates and a reflective layer is provided on each of pixels, and a polarizer plate, the liquid crystal display device comprising: a circular polarizer/analyzer structure including the polarizer plate and the first retardation plate; and a variable retarder structure including the liquid crystal cell, wherein the variable retarder structure has an optically positive normal-directional phase difference in a black display state, the first retardation plate is a uniaxial ¼ wavelength plate which provides a phase difference of a ¼ wavelength between light rays of predetermined wavelengths that travel along a fast axis and a slow axis thereof, the circular polarizer/analyzer structure includes a first optical compensation layer which is disposed for optical compensation of the circular polarizer/analyzer structure between the polarizer plate and the first retardation plate, the first optical compensation layer including a uniaxial second retardation plate with a refractive index anisotropy of nx≈ny<nz, and the variable retarder structure includes a second optical compensation layer which is disposed for optical compensation of the variable retarder structure between the first retardation plate and the liquid crystal cell, the second optical compensation layer including a third retardation plate with a refractive index anisotropy of nx≈ny>nz.

The present invention can provide a liquid crystal display device that can improve viewing angle characteristics and can reduce cost.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A schematically shows an example of the cross-sectional structure of a liquid crystal display device according to an embodiment of the present invention;

FIG. 1B schematically shows another example of the cross-sectional structure of the liquid crystal display device according to the embodiment of the present invention;

FIG. 1C schematically shows still another example of the cross-sectional structure of the liquid crystal display device according to the embodiment of the present invention;

FIG. 2 is a view for explaining a refractive index ellipsoid of a first retardation plate and a second retardation plate, which are applicable to the liquid crystal display device according to the embodiment;

FIG. 3A is a view for explaining a refractive index ellipsoid of a third retardation plate and a fourth retardation plate, which are applicable to the liquid crystal display device according to the embodiment;

FIG. 3B is a view for explaining a refractive index ellipsoid of a fifth retardation plate, which is applicable to the liquid crystal display device according to the embodiment;

FIG. 4 is a view for explaining a refractive index ellipsoid of a sixth retardation plate and a seventh retardation plate, which are applicable to the liquid crystal display device according to the embodiment;

FIG. 5 is a view for explaining a compensation principle of contrast/viewing angle characteristics of the liquid crystal display device shown in FIG. 1A;

FIG. 6 is a view for explaining an optimizing condition for a first optical compensation layer, a second optical compensation layer and a third optical compensation layer, which are applied to the liquid crystal display device according to the embodiment;

FIG. 7A shows a measurement result of isocontrast curves of a liquid crystal display device according to Embodiment 1;

FIG. 7B shows a measurement result of isocontrast curves of a liquid crystal display device according to Embodiment 2;

FIG. 7C shows a measurement result of isocontrast curves of a liquid crystal display device according to Embodiment 3;

FIG. 7D shows a measurement result of isocontrast curves of a liquid crystal display device according to Embodiment 4;

FIG. 8 shows a measurement result of isocontrast curves of a liquid crystal display device according to Comparative Example 1;

FIG. 9 schematically shows an example of the cross-sectional structure of a liquid crystal display device according to Comparative Example 2;

FIG. 10 shows an example of isocontrast curves of the liquid crystal display device shown in FIG. 9;

FIG. 11 schematically shows an example of the cross-sectional structure of a liquid crystal display device according to Comparative Example 3;

FIG. 12 is a view for explaining a refractive index ellipsoid of a biaxial ¼ wavelength plate, which is used in the liquid crystal display device shown in FIG. 11;

FIG. 13 shows an example of isocontrast curves of the liquid crystal display device shown in FIG. 11;

FIG. 14 is a view for describing an example of the cross-sectional structure of a liquid crystal display device according to Comparative Example 4;

FIG. 15 is a view for explaining a refractive index ellipsoid of a biaxial ¼ wavelength plate, which is used in the liquid crystal display device shown in FIG. 14;

FIG. 16 shows an example of isocontrast curves of the liquid crystal display device shown in FIG. 14; and

FIG. 17 schematically shows an example of the cross-sectional structure of the liquid crystal display device according to another embodiment of the present invention.

### DETAILED DESCRIPTION OF THE INVENTION

A liquid crystal display device according to an embodiment of the present invention will now be described with reference to the accompanying drawings.

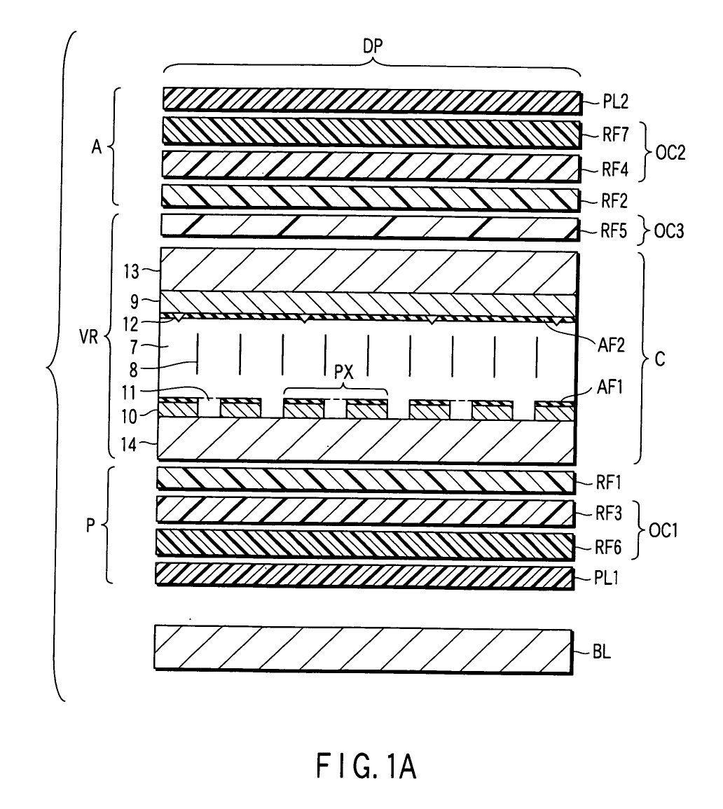

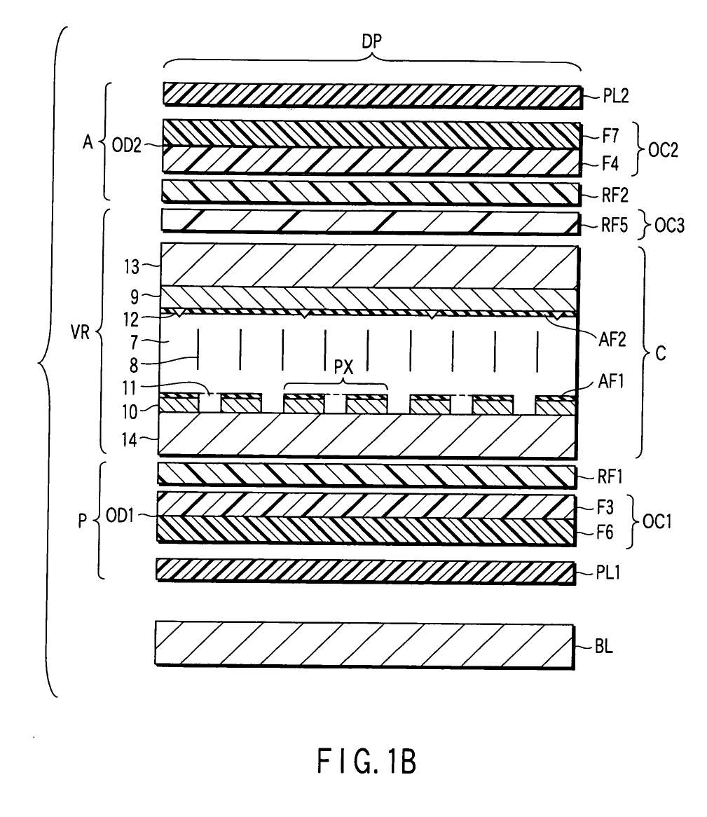

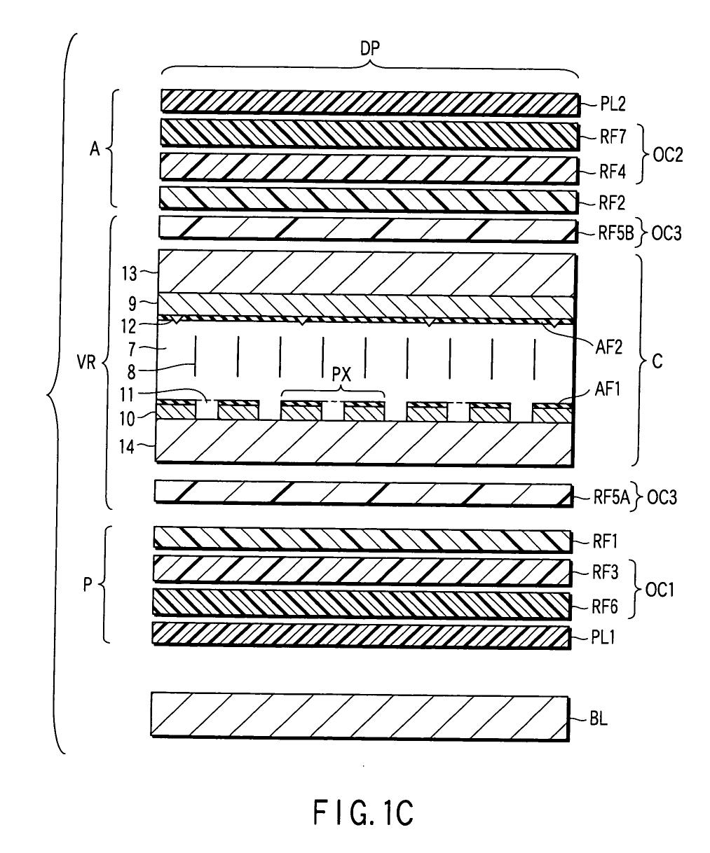

FIG. 1A schematically shows the structure of a liquid crystal display device according an embodiment of the invention. As is shown in FIG. 1A, the liquid crystal display device includes a liquid crystal cell of a circular-polarization-based vertical alignment mode in which liquid crystal molecules in each pixel are aligned substantially vertical to the major surface of the substrate in a voltage-off state. The liquid crystal display device comprises a circular polarizer structure P, a variable retarder structure VR and a circular analyzer structure A.

The variable retarder structure VR includes a dot-matrix liquid crystal cell C in which a liquid crystal layer is held two electrode-equipped substrates. Specifically, this liquid crystal cell C is an MVA mode liquid crystal cell, and a liquid crystal layer 7 is sandwiched between an active matrix substrate 14 and a counter-substrate 13. The gap between the active matrix substrate 14 and counter-substrate 13 is kept constant by a spacer (not shown). The liquid crystal cell C includes a display region DP for displaying an image. The display region DP is composed of pixels PX that are arranged in a matrix.

The active matrix substrate 14 is formed using an insulating substrate with light transmissivity, such as a glass substrate. One major surface of the active matrix substrate 14 is provided with, e.g. various lines such as scan lines and signal lines, and switching elements provided near intersections of the scan lines and signal lines. A description of these elements is omitted since they are not related to the operation of the present invention. Pixel electrodes 10 are provided on the active matrix substrate 14 in association with the respective pixels PX. The surfaces of the pixel electrodes 10 are covered with an alignment film AF1.

The various lines, such as scan lines and signal lines, are formed of aluminum, molybdenum, copper, etc. The switching element is a thin-film transistor (TFT) including a semiconductor layer of, e.g. amorphous silicon or polysilicon, and a metal layer of, e.g. aluminum, molybdenum, chromium, copper or tantalum. The switching element is connected to the scan line, signal line and pixel electrode 10. On the active matrix substrate 14 with this structure, a voltage can selectively be applied to a desired one of the pixel electrodes 10.

The pixel electrode 10 is formed of an electrically conductive material with light transmissivity, such as indium tin oxide (ITO). The pixel electrode 10 is formed by providing a thin film using, e.g. sputtering, and then patterning the thin film using a photolithography technique and an etching technique.

The alignment film AF1 is formed of a thin film of a resin material with light transmissivity, such as polyimide. In this embodiment, the alignment film AF1 is not subjected to a rubbing process, and liquid crystal molecules 8 are vertically aligned.

The counter-substrate 13 is formed using an insulating substrate with light transmissivity, such as a glass substrate. A common electrode 9 is provided on one major surface of the counter-substrate 13. The surface of the common electrode 9 is covered with an alignment film AF2.

The common electrode 9, like the pixel electrode 10, is formed of an electrically conductive material with light transmissivity, such as ITO. The alignment film AF2, like the alignment film AF1 on the active matrix substrate 14, is formed of a resin material with light transmissivity, such as polyimide. In this embodiment, the common electrode 9 is formed as a planar continuous film that faces all the pixel electrodes with no discontinuity.

When the present display device is constructed as a color liquid crystal device, the liquid crystal cell C includes color filter layers. The color filter layers are color layers of, e.g. the three primary colors of blue, green and red. The color filter may be provided between the insulating substrate of the active matrix substrate 14 and the pixel electrode 10 with a COA (Color-filter On Array) structure, or may be provided on the counter-substrate 13.

If the COA structure is adopted, the color filter layer is provided with a contact hole, and the pixel electrode 10 is connected to the switching element via the contact hole. The COA structure is advantageous in that high-precision alignment using, e.g. alignment marks is needless when the liquid crystal cell C is to be formed by attaching the active matrix substrate 14 and counter-substrate 13.

The circular polarizer structure P includes a first polarizer plate PL1 that is located on a light source side of the liquid crystal cell C, that is, on a backlight unit BL side, and a uniaxial first retardation plate RF1 that is disposed between the first polarizer plate PL1 and liquid crystal cell C. The circular analyzer structure A includes a second polarizer plate PL2 that is disposed on the observation surface side of the liquid crystal cell C, and a uniaxial second retardation plate RF2 that is disposed between the second polarizer plate PL2 and liquid crystal cell C.

Each of the first polarizer plate PL1 and second polarizer plate PL2 has a transmission axis and an absorption axis, which are substantially perpendicular to each other in the plane thereof. The first retardation plate PL1 and second retardation plate PL2 are disposed such that their transmission axes intersect at right angles with each other.

Each of the first retardation plate RF1 and second retardation plate RF2 is a uniaxial ¼ wavelength plate that has a fast axis and a slow axis, which are substantially perpendicular to each other, and provides a phase difference of ¼ wavelength between light rays with a predetermined wavelength (e.g. 550 nm), which pass through the fast axis and slow axis. The first retardation plate RF1 and second retardation plate RF2 are disposed such that their slow axes intersect at right angles with each other.

The liquid crystal display device with this structure, which includes, in particular, a transmission part in at least a part of the pixel PX or in at least a part of the display region DP, is constructed by successively stacking the backlight unit BL, circular polarizer structure P, variable retarder structure VR and circular analyzer structure A.

The liquid crystal display device with this structure includes a first optical compensation layer OC1, which is disposed for optical compensation of the circular polarizer structure P between the first polarizer plate PL1 and first retardation plate RF1; a second optical compensation layer OC2, which is disposed for optical compensation of the circular analyzer structure A between the second polarizer plate PL2 and second retardation plate RF2; and a third optical compensation layer OC3, which is disposed for optical compensation of the variable retarder structure VR between the first retardation plate RF1 and second retardation plate RF2.

Specifically, the first optical compensation layer OC1 is provided in the circular polarizer structure P, and includes at least an optically uniaxial third retardation plate (positive C-plate) RF3 which has a refractive index anisotropy of nx≈ny<nz. Thereby, the first optical compensation layer OC1 compensates the viewing angle characteristics of the circular polarizer structure P so that emission light from the circular polarizer structure P may become substantially circularly polarized light, regardless of the direction of emission.

The second optical compensation layer OC2 is provided in the circular analyzer structure A, and includes at least an optically uniaxial fourth retardation plate (positive C-plate) RF4 which has a refractive index anisotropy of nx≈ny<nz. Thereby, the second optical compensation layer OC2 compensates the viewing angle characteristics of the circular analyzer structure A so that emission light from the circular analyzer structure A may become substantially circularly polarized light, regardless of the direction of emission.

The third optical compensation layer OC3 is provided in the variable retarder structure VR, and includes at least an optically uniaxial fifth retardation plate (negative C-plate) RF5 which has a refractive index anisotropy of nx≈ny>nz. Thereby, the third optical compensation layer OC3 compensates the viewing angle characteristics of the liquid crystal cell C in the variable retarder structure VR (i.e. an optically positive normal-directional phase difference of the liquid crystal layer 7 in the state in which the liquid crystal molecules 8 are aligned substantially vertical to the major surface of the substrate, that is, in the state of black display).

In the example shown in FIG. 1A, the first optical compensation layer OC1 further includes an optically uniaxial sixth retardation plate (negative A-plate) RF6 which has a refractive index anisotropy of nx<ny≈nz. The sixth retardation plate RF6 is disposed such that its slow axis is substantially parallel to the transmission axis of the first polarizer plate PL1. In this example, the sixth retardation plate RF6 is positioned between the first polarizer plate PL1 and third retardation plate RF3.

The second optical compensation layer OC2 further includes an optically uniaxial seventh retardation plate (negative A-plate) RF7 which has a refractive index anisotropy of nx<ny≈nz. The seventh retardation plate RF7 is disposed such that its slow axis is substantially parallel to the transmission axis of the second polarizer plate PL2. In this example, the seventh retardation plate RF7 is positioned between the second polarizer plate PL2 and fourth retardation plate RF4.

In the example shown in FIG. 1A, the fifth retardation plate RF5, which constitutes the third optical compensation layer OC3, is disposed between the liquid crystal cell C and the second retardation RF2. However, the same advantageous effect is obtained even if the fifth retardation plate RF5 is disposed between the liquid crystal cell C and the first retardation plate RF1.

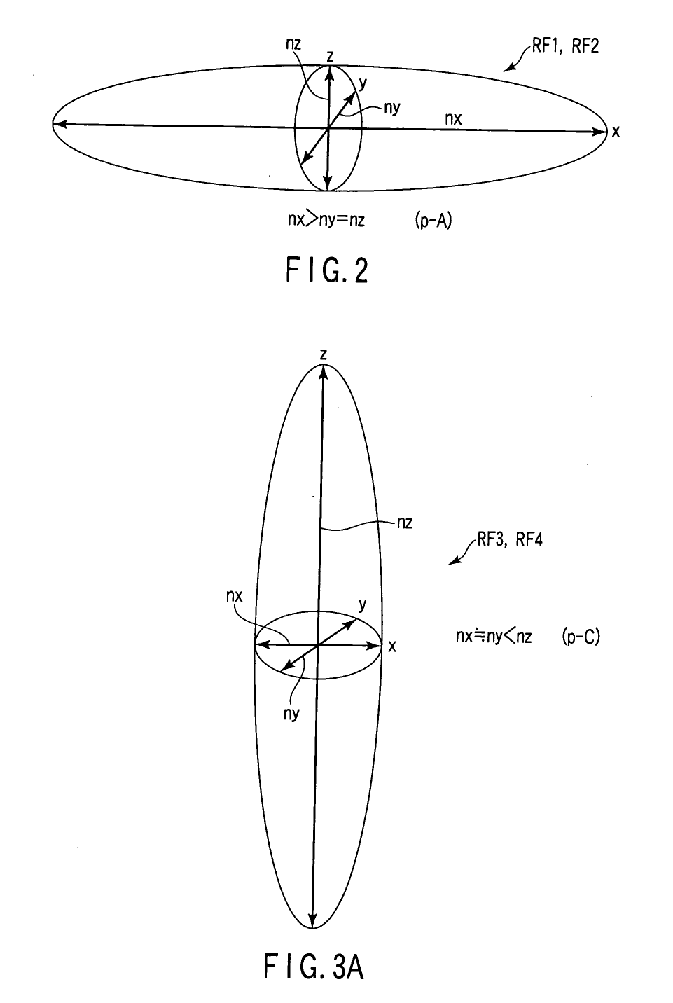

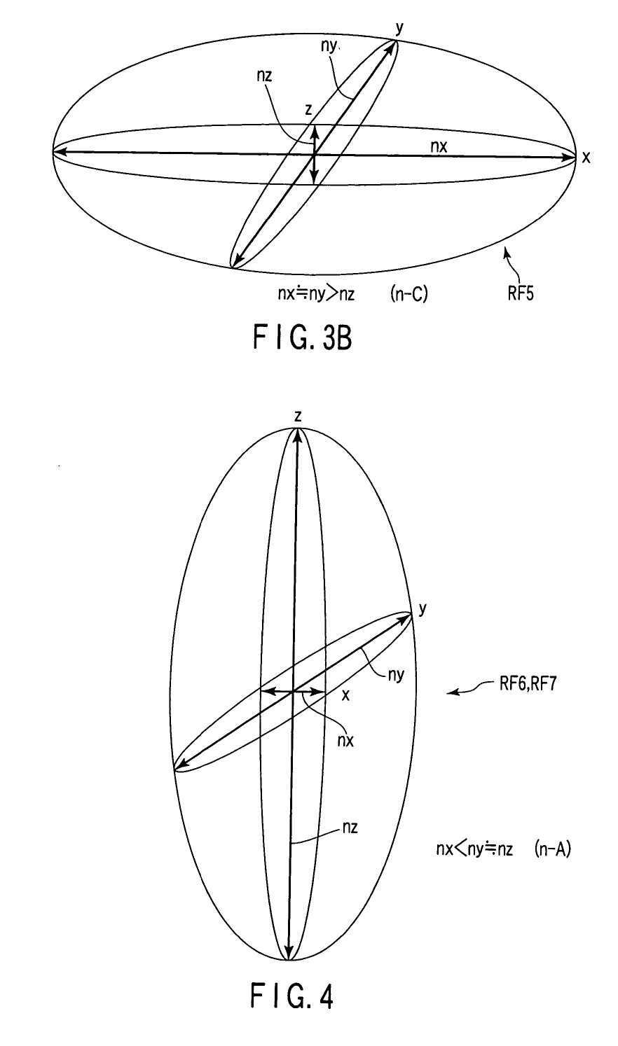

A retardation plate that is applicable to the first retardation plate RF1 and second retardation plate RF2 should have a refractive index anisotropy (nx>ny=nz) as shown in FIG. 2. A retardation plate that is applicable to the third retardation plate RF3 and fourth retardation plate RF4 should have a refractive index anisotropy (nx≈ny<nz) as shown in FIG. 3A. A retardation plate that is applicable to the fifth retardation plate RF5 should have a refractive index anisotropy (nx≈ny>nz) as shown in FIG. 3B. A retardation plate that is applicable to the sixth retardation plate RF6 and seventh retardation plate RF7 should have a refractive index anisotropy (nx<ny≈nz) as shown in FIG. 4. In FIG. 2 to FIG. 4, nx and ny designate refractive indices in two mutually perpendicular directions in the major surface of each retardation plate, and nz indicates the refractive index in the normal direction to the major surface of the retardation plate.

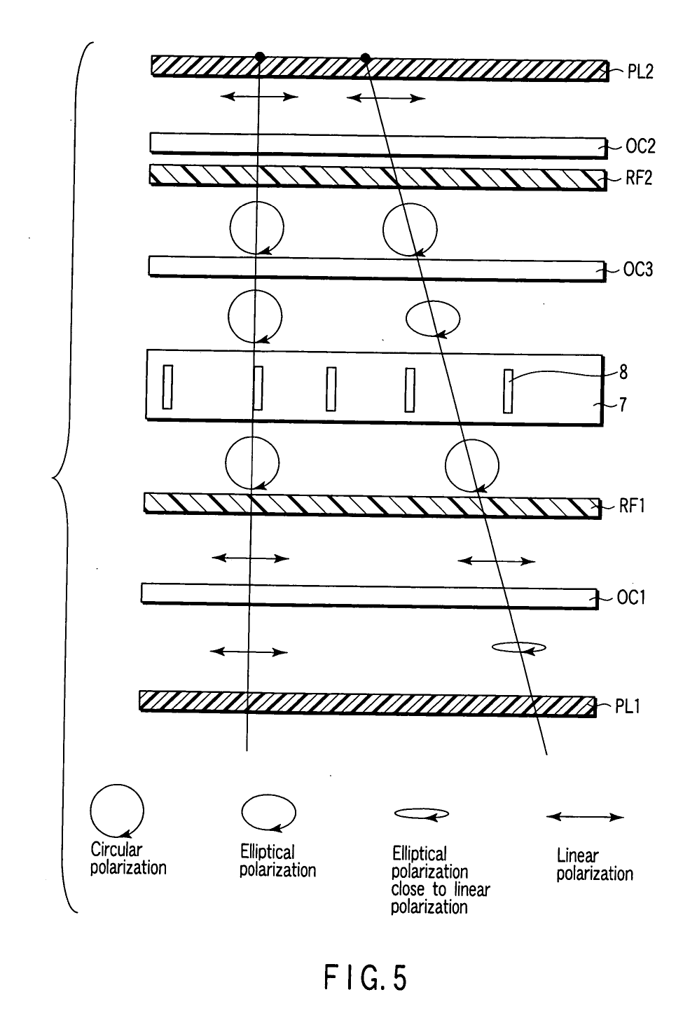

FIG. 5 is a conceptual view of the polarization state in respective optical paths, illustrating the optical principle of the viewing angle characteristics of the liquid crystal display device shown in FIG. 1A.

The liquid crystal display device uses the third optical compensation layer OC3 including the optically negative fifth retardation plate RF5, which is made to function as a negative retardation plate along with the separately provided first retardation plate RF1 and second retardation plate RF2. Thereby, the viewing angle dependency of the optically positive phase difference (normal-directional phase difference) in the normal direction of the liquid crystal layer 7, whose Δn·d is 280 nm or more, is compensated. The third optical compensation layer OC3 with this compensation function is provided between the first retardation plate RF1 and second retardation plate RF2. Thus, if light that is incident on the first retardation plate RF1 and second retardation plate RF2 is linearly polarized light, the light that is emitted from the first retardation plate RF1 and second retardation plate RF2 becomes substantially circularly polarized light, regardless of the emission angle or emission direction.

Accordingly, in the case where the third optical compensation layer OC3 is situated between the liquid crystal layer 7 and second retardation plate RF2, the light that is incident on the liquid crystal layer 7 becomes circularly polarized light, irrespective of the incidence angle or incidence direction. Even if the circularly polarized light becomes elliptically polarized light due to the normal-directional phase difference of the liquid crystal layer 7, the elliptically polarized light is restored to the circularly polarized light by the function of the third optical compensation layer OC3. Thus, the light that is incident on the second retardation plate RF2 disposed on the third optical compensation layer OC3 becomes circularly polarized light, irrespective of the incidence angle or incidence direction. Therefore, good display characteristics can be obtained regardless of the viewing direction.

In the case where the third optical compensation layer OC3 is situated between the liquid crystal layer 7 and first retardation plate RF1, the light that is incident on the third optical compensation layer OC3 becomes circularly polarized light, irrespective of the incidence angle or incidence direction. Even if the circularly polarized light becomes elliptically polarized light due to the normal-directional phase difference of the third optical compensation layer OC3, the elliptically polarized light is restored to the circularly polarized light by the function of the liquid crystal layer 7. Thus, the light that is incident on the second retardation plate RF2 disposed on the liquid crystal layer 7 becomes circularly polarized light, irrespective of the incidence angle or incidence direction. Therefore, good display characteristics can be obtained irrespective of the viewing direction, as in the case where the third optical compensation layer OC3 is disposed between the liquid crystal layer 7 and second retardation plate RF2.

As has been described above, in the liquid crystal display device structure of this embodiment, polarized light, which is incident on the liquid crystal layer 7 and third optical compensation layer OC3 that compensates the normal-directional phase difference of the liquid crystal layer 7, is circularly polarized light which has no directional polarity. Therefore, the compensation effect, which does not depend on the direction of alignment of liquid crystal molecules, can be obtained.

In order to sufficiently obtain the above-described advantageous effect, the first optical compensation layer OC1, which comprises such optically uniaxial retardation plates as to compensate the viewing-angle characteristics of the first retardation plate RF1 and first polarizer plate PL1, may be disposed between the first retardation plate RF1 and first polarizer plate PL1, which are located on the light source side. In addition, the second optical compensation layer OC2, which comprises such optically uniaxial retardation plates as to compensate the viewing-angle characteristics of the second retardation plate RF2 and second polarizer plate PL2, may be disposed between the second retardation plate RF2 and second polarizer plate PL2, which are located on the observer side. Thereby, better viewing-angle characteristics can be obtained.

If biaxial retardation plates are used, viewing-angle characteristics can be improved. However, in the structure of the present embodiment, the uniaxial first retardation plate (¼ wavelength plate) RF1 is combined with the third retardation plate RF3 of the first optical compensation layer OC1. Thereby, substantially the same function as the function of the biaxial retardation plate, which can improve viewing-angle characteristics, can be obtained. Similarly, the uniaxial second retardation plate (¼ wavelength plate) RF2 is combined with the fourth retardation plate RF4 of the second optical compensation layer OC2. Thereby, substantially the same function as the function of the biaxial retardation plate, which can improve viewing-angle characteristics, can be obtained. Thus, the viewing-angle characteristics can be improved and the manufacturing cost can be made lower than in the case of using the biaxial retardation plate.

In the liquid crystal display device of the above-described embodiment, the multi-domain vertical alignment (MVA) mode, in which liquid crystal molecules in the pixel are controlled and oriented in at least two directions in a voltage-on state, is applied to the liquid crystal cell C. In the MVA mode, it is preferable to form such a domain that the orientation direction of liquid crystal molecules 8 in the pixel PX in a voltage-on state is substantially parallel to the absorption axis or transmission axis of the first polarizer plate PL1 in at least half the opening region of each pixel PX.

This orientation control can be realized by providing a protrusion 12 for forming the multi-domain structure in the pixel PX, as shown in FIG. 1A. The orientation control can also be realized by forming a slit 11 for forming the multi-domain structure in at least one of the pixel electrode 10 and counter-electrode 9 which are disposed in each pixel PX. Further, the orientation control can be realized by providing alignment films AF1 and AF2, which are subjected to an orientation process of, e.g. rubbing, for forming the multi-domain structure, on those surfaces of the active matrix substrate 14 and counter-substrate 13, which sandwich the liquid crystal layer 7. Needless to say, at least two of the protrusion 12, slit 11 and orientation film AF1, AF2 that is subjected to the orientation process may be combined.

In the case of the circular-polarization-based MVA mode liquid crystal display device, the transmittance does not depend on the liquid crystal molecule orientation direction in the pixel in the voltage-on state. Thus, if a phase difference of ½ wavelength is obtained by the liquid crystal layer 7 and fifth retardation plate RF5, excellent transmittance characteristics can be obtained regardless of the liquid crystal molecule orientation direction.

In the MVA mode, the multi-domain structure is constituted in each pixel so as to obtain the above-mentioned phase difference of ½ wavelength regardless of the light incidence angle. However, depending on the incidence angle or the tilt angle of liquid crystal molecules, there may be a case where the orientation dependence of phase difference cannot be compensated by the multi-domain effect. In order to minimize this problem, the liquid crystal molecule orientation direction should be made parallel to the transmission axis or absorption axis of the polarizer plate. The reason is that when the light that emerges from the liquid crystal layer 7 and fifth retardation plate RF5 becomes elliptically polarized light, and not circularly polarized light, the major-axis direction of the elliptically polarized light becomes parallel to the optical axis (transmission axis and absorption axis) of the second polarizer plate PL2 that is the analyzer.

Preferably, in the liquid crystal display device according to the present embodiment, the first retardation plate RF1 and the second retardation plate RE2 should be formed of a resin that has a retardation value, which hardly depends on an incidence light wavelength in a plane thereof, such as ARTON resin, polyvinyl alcohol resin, ZEONOR resin, or triacetyl cellulose resin. Alternatively, the first retardation plate RF1 and the second retardation plate RF2 should preferably be formed of a resin that has a retardation value, which is about ¼ of incident light wavelength in a plane thereof regardless of incident light wavelength, such as denatured polycarbonate resin. Polarization with less wavelength dispersion dependency of incident light can be obtained by using, not a material such as polycarbonate which has a greater retardation in the shorter-wavelength side, but a material with a constant refractive index in all wavelength ranges or a material such as denatured polycarbonate which always has a retardation value of ¼ wavelength regardless of incident light wavelength.

The third retardation plate RF3 and fourth retardation plate RF4 should preferably be formed of a nematic liquid crystal polymer having a normal-directional optical axis. It is difficult to form a film with a positive phase difference in the normal direction by a conventional drawing technique. The formation is made easier by using a nematic liquid crystal polymer or a discotic liquid crystal polymer, which has a normal-directional optical axis, and the cost can be reduced.

The fifth retardation plate RF5 should preferably be formed of one of a chiral nematic liquid crystal polymer, a cholesteric liquid crystal polymer and a discotic liquid crystal polymer.

In the present embodiment, as described above, the fifth retardation plate RF5 is employed in order to compensate the normal-directional phase difference of the liquid crystal layer 7. The phase difference of the liquid crystal layer 7, which is to be compensated, has wavelength dispersion. In order to compensate the phase difference of the liquid crystal layer 7 including the wavelength dispersion, a more excellent compensation effect can be obtained if the fifth retardation plate RF5 has similar wavelength dispersion. It is thus preferable to form the fifth retardation plate RF5 of the above-mentioned liquid crystal polymer.

The sixth retardation plate RF6 and seventh retardation plate RF7 should preferably be formed of a discotic liquid crystal polymer having an in-plane optical axis. It is difficult to form a film with a negative phase difference in the in-plane direction by a conventional drawing technique. The formation is made easier by using a discotic liquid crystal polymer, and the cost can be reduced.

As is shown in FIG. 1B, in the liquid crystal display device according to the present embodiment, the first optical compensation layer OC1 may be formed of an optical device OD1 in which the total optical function is equivalent to biaxial refractive index anisotropy of nx<ny<nz. For example, a functional layer F3, which functions as the third retardation plate RF3, and a functional layer F6, which functions as the sixth retardation plate RF6, are formed on the same plane (e.g. the first retardation plate RF1). Thereby, a single retardation plate, which has substantially the same optical function as the biaxial refractive index anisotropy, can be formed. The functional layers F3 and F6 can be formed of, for instance, the above-mentioned materials.

The second optical compensation layer OC2 may be formed of an optical device OD2 in which the total optical function is equivalent to biaxial refractive index anisotropy of nx<ny<nz. For example, a functional layer F4, which functions as the fourth retardation plate RF4, and a functional layer F7, which functions as the seventh retardation plate RF7, are formed on the same plane (e.g. the second retardation plate RF2). Thereby, a single retardation plate, which has substantially the same optical function as the biaxial refractive index anisotropy, can be formed.

As described above, at least one of the first optical compensation layer OC1 and second optical compensation layer OC2 may be formed as a single unit. Thereby, the number of components can be reduced, the total layer thickness can be reduced, and the reduction in thickness of the device can advantageously be realized.

The fifth retardation plate RF5 may be formed on the first retardation plate RF1 or second retardation plate RF2. Thereby, an optical device, in which the total optical function is equivalent to biaxial refractive index anisotropy of nx>ny>nz, may be formed. For example, by forming a functional layer, which functions as the fifth retardation plate RF5, on the first retardation plate RF1 or second retardation plate RF2, it is possible to construct a single retardation plate which has substantially the same optical function as biaxial refractive index anisotropy. In this manner, the combination of the fifth retardation plate RF5 and first retardation plate RF1 or the combination of the fifth retardation plate RF5 and second retardation plate RF2 may be formed as a single unit. Thereby, the number of components can be reduced, the total layer thickness can be reduced, and the reduction in thickness of the device can advantageously be realized.

The fifth retardation plate RF5 shown in FIG. 1A may be divided into two parts so that the function thereof is shared by the two parts. Specifically, as shown in FIG. 1C, the third optical compensation layer OC3 may include a first segment layer RF5A, which is disposed between the first retardation plate RF1 and the liquid crystal cell C, and a second segment layer RF5B, which is disposed between the second retardation plate RF2 and the liquid crystal cell C, so that the first segment layer RF5A and second segment layer RF5B may have the function of the fifth retardation plate. In this structure, the total thickness of the first segment layer RFSA and second segment layer RF5B is set to be, for instance, T, which is the thickness of the functional layer of the fifth retardation plate RF5.

In the above structure, the first segment layer RFSA may be formed on the first retardation plate RF1, thereby to form an optical device in which the total optical function is equivalent to biaxial refractive index anisotropy of nx>ny>nz. For example, by forming the first segment layer RF5A on the first retardation plate RF1, it becomes possible to form a single retardation plate which has substantially the same optical function as biaxial refractive index anisotropy.

Similarly, the second segment layer RF5B may be formed on the second retardation plate RF2, thereby to form an optical device in which the total optical function is equivalent to biaxial refractive index anisotropy of nx>ny>nz. For example, by forming the second segment layer RF5B on the second retardation plate RF2, it becomes possible to form a single retardation plate which has substantially the same optical function as biaxial refractive index anisotropy.

In this manner, at least one of the combination of the first segment layer RF5A and first retardation plate RF1 and the combination of the second segment layer RF5A and second retardation plate RF2 may be formed as a single unit. Thereby, the number of components can be reduced, the total layer thickness can be reduced, and the reduction in thickness of the device can advantageously be realized.

The above-described single optical device which has the functions of plural retardation plates can be realized under a condition which is difficult to meet in the case of a biaxial drawn film, for example, under such a condition that a normal-directional phase difference of +40 to 60 nm is added to the sixth retardation plate RF6 (or seventh retardation plate RF7) having an in-plane phase difference of +140 nm. Moreover, the cost can be reduced.

Next, the optimization of the first optical compensation layer OC1, second optical compensation layer OC2 and third optical compensation layer OC3 is described.

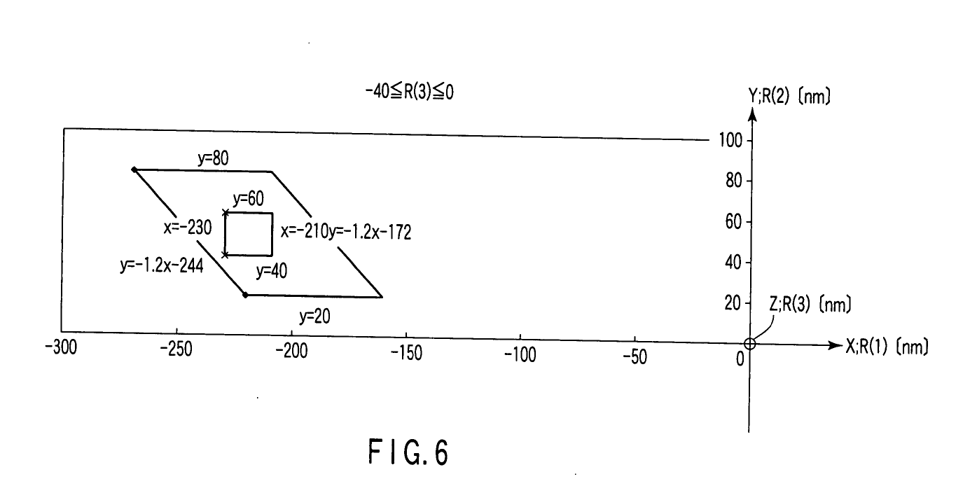

As shown in FIG. 6, assume now that the normal-directional phase difference of the third retardation plate RF3 that is included in the first optical compensation layer OC1 and the fourth retardation plate RF4 that is included in the second optical compensation layer OC2 is R(1), the normal-directional phase difference of the fifth retardation plate RF5 that is included in the third optical compensation layer OC3 is R(2), and the normal-directional phase difference of the sixth retardation plate RF6 that is included in the first optical compensation layer OC1 and the seventh retardation plate RF7 that is included in the second optical compensation layer OC2 is R(3). In this case, an orthogonal coordinate system, in which the values of R(1), R(2) and R(3) are set to be X, Y and Z values, is defined.

Specifically, in the third retardation plate RF3, R(1) corresponds to (nz−nx(or ny))×(thickness of third retardation plate RF3). In the fourth retardation plate RF4, R(1) corresponds to (nz−nx (or ny))×(thickness of fourth retardation plate RF4) In the fifth retardation plate RF5, R(2) corresponds to (nz−nx (or ny))×(thickness of fifth retardation plate RF5). In the case where the fifth retardation plate RF5 is composed of the first segment layer RF5A and second segment layer RF5B, R(2) corresponds to (nz−nx(or ny))×(thickness of first segment layer RF5A+thickness of second segment layer RF5B).

In the sixth retardation plate RF6, R(3) corresponds to (nz−nx (or ny))×(thickness of sixth retardation plate RF6). In the seventh retardation plate RF7, R(3) corresponds to (nz−nx(or ny))×(thickness of seventh retardation plate RF7).

On the display region (screen) DP of the liquid crystal display device, in order to set the color hue C* in white display at 10 or less, it is necessary to make such a structure that the effective retardation (Δn·d) of the liquid crystal layer 7 is 210 nm or less. Taking into account the fact that an application voltage for general TFT driving is 10 V, the retardation (Δn·d) of the liquid crystal layer 7 in the voltage-off state needs to be 360 nm or less. On the other hand, in order to achieve 60% or more of the function of the TN mode, Δn·d needs to be 280 nm or more.

It has been made clear that when the screen is observed in the range of Δn·d of the liquid crystal layer 7 between 280 nm and 360 nm, an optimizing condition, which is to be satisfied in order to obtain a viewing angle of 60° or more with a contrast ratio of 10:1 or more in the direction of a least viewing angle, is:
−6/5×R(1)−244≦R(2)≦−6/5×R(1)−172,
and
20≦R(2)≦80, and
−40≦R(3)≦0.

It is also made clear that a more preferable optimizing condition, which is to be satisfied in order to obtain a viewing angle of 60° or more with a contrast ratio of 10:1 or more in the direction of a least viewing angle, is:
−230≦R(1)≦−210, and
40≦R(2)≦60, and
−40≦R(3)≦0.

As has been described above, in the liquid crystal display device according to the present embodiment, the viewing-angle compensation function of the liquid crystal layer 7 and the viewing-angle compensation functions of the circular polarizer structure and circular analyzer structure are separated. Thereby, the wavelength dispersion of each component can individually be controlled. Compared to the prior art in which the wavelength dispersions of the respective components are controlled at the same time, the compensation effect for wavelengths can advantageously be enhanced.

Specific embodiments of the present invention will be described below. The main structural components are the same as those described with reference to FIG. 1A, etc.

### EMBODIMENT 1

In a liquid crystal display device according to Embodiment 1, an F-based liquid crystal (manufactured by Merck Ltd.) was used as a nematic liquid crystal material with negative dielectric anisotropy for the liquid crystal layer 7. The refractive index anisotropy Δn of the liquid crystal material used in this case is 0.095 (wavelength for measurement=550 nm; in the description below, all refractive indices and phase differences of retardation plates are values measured at wavelength of 550 nm), and the thickness d of the liquid crystal layer 7 is 3.5 μm. Thus, the Δn·d of the liquid crystal layer 7 is 330 nm.

In Embodiment 1, a uniaxial ¼ wavelength plate (in-plane phase difference=140 nm), which is formed of ZEONOR resin (manufactured by Nippon Zeon Co., Ltd.), is used as the first retardation plate RF1 and second retardation plate RF2. An alignment film, which is formed of JALS214-R14 (manufactured by JSR), is provided on the surface (opposed to the polarizer plate) of the film used as the first retardation plate RF1. Subsequently, a nematic liquid crystal polymer (manufactured by Merck Ltd.) is coated. The refractive index anisotropy Δn of this liquid crystal polymer is 0.040, and the thickness d thereof is 1.25 μm. Thus, the normal-directional phase difference of the liquid crystal polymer is 50 nm. This liquid crystal polymer functions as the third retardation plate RF3.

Similarly, a liquid crystal polymer layer with a normal-directional phase difference of 50 nm is formed on the surface of the film that is used as the second retardation plate RF2. This liquid crystal polymer layer functions as the fourth retardation plate RF4. On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 2.36 μm, which has a refractive index anisotropy Δn of 0.102 and a helical pitch of 0.9 μm. The coated liquid crystal polymer layer is irradiated with ultraviolet in the state in which the helical axis agrees with the normal direction of the film. This liquid crystal polymer layer functions as the fifth retardation plate RF5. The normal-directional phase difference of the fifth retardation plate RF5, which is thus obtained, is −220 nm.

The first retardation plate RF1 having the function of the third retardation plate RF3 is attached via an adhesive layer, such as glue, such that the first retardation plate RF1 is opposed to the liquid crystal layer 7. In addition, a polarizer plate of SRW062A (manufactured by Sumitomo Chemical Co., Ltd.) is attached as the first polarizer plate PL1 via an adhesive layer, such as glue, on the third retardation plate RF3.

On the other hand, the second retardation plate RF2, which functions as the fourth retardation plate RF4 and fifth retardation plate RF5, is attached via an adhesive layer, such as glue, such that the fifth retardation plate RF5 is opposed to the liquid crystal layer 7. In addition, a polarizer plate of SRW062A (manufactured by Sumitomo Chemical Co., Ltd.) is attached as the second polarizer plate PL2 via an adhesive layer, such as glue, on the fourth retardation plate RF4.

The angle between the transmission axis of each of the first polarizer plate PL1 and second polarizer plate PL2 and the slow axis of each of the first retardation plate RF1 and second retardation plate RF2 is π/4 (rad). The transmission axis of the first polarizer plate PL1 and the slow axis of the third retardation plate RF3 are parallel. Protrusions 12 and slits 11 are arranged such that the orientation direction of liquid crystal molecules at the time when voltage is applied to the liquid crystal layer 7 is parallel or perpendicular to the transmission axes of the first polarizer plate PL1 and second polarizer plate PL2. The absorption axis of the second polarizer plate PL2 and the absorption axis of the first polarizer plate PL1 are disposed to intersect at right angles with each other. Further, the slow axis of the first retardation plate RF1 and the slow axis of the second retardation plate RF2 are disposed to intersect at right angles with each other.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

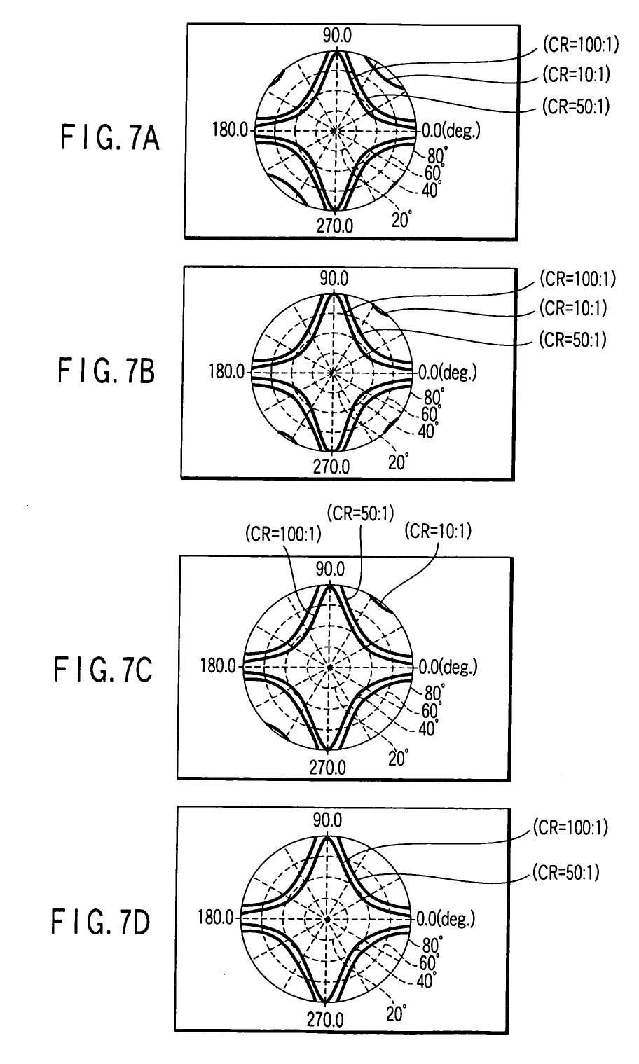

FIG. 7A shows an example of the measurement result of isocontrast curves. The 0 deg. azimuth and 180 deg. azimuth correspond to the horizontal direction of the screen, and the 90 deg. azimuth and 270 deg. azimuth correspond to the vertical direction of the screen. It was confirmed that in almost all azimuth directions, the viewing angle with a contrast ratio of 10:1 or more was ±80° or more, and excellent viewing angle characteristics were obtained. In addition, the transmittance at 4.2 V was measured, and it was confirmed that a very high transmittance of 5.0% was obtained.

### EMBODIMENT 2

The structure of a liquid crystal display device according to Embodiment 2 is the same as the structure of the liquid crystal display device according to Embodiment 1, except that the fifth retardation plate RF5 is composed of two segments, as shown in FIG. 1C.

Specifically, in Embodiment 2, a liquid crystal polymer layer, which functions as the third retardation plate RF3, is formed on the surface (opposed to the polarizer plate) of the film used as the first retardation plate RF1. On the other hand, the back surface (opposed to the liquid crystal cell C) of the film that is used as the first retardation plate RF1 is rubbed, and the rubbed surface is coated with an ultraviolet cross-linking chiral nematic liquid crystal (manufactured by Merck Ltd.) with a thickness of 1.18 μm, which has a refractive index anisotropy Δn of 0.102 and a helical pitch of 0.9 μm. The coated liquid crystal polymer layer is irradiated with ultraviolet in the state in which the helical axis agrees with the normal direction of the film. This liquid crystal polymer layer functions as a first segment layer of the fifth retardation plate RF5. The normal-directional phase difference of the first segment layer, which is thus obtained, is −110 nm.

Similarly, a liquid crystal polymer layer, which functions as the fourth retardation plate RF4, is formed on the surface of the film used as the second retardation plate RF2. On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 1.18 μm, which has a refractive index anisotropy Δn of 0.102 and a helical pitch of 0.9 μm. The coated liquid crystal polymer layer is irradiated with ultraviolet in the state in which the helical axis agrees with the normal direction of the film. This liquid crystal polymer layer functions as a second segment layer of the fifth retardation plate RF5. The normal-directional phase difference of the second segment layer, which is thus obtained, is −110 nm.

This first retardation plate RF1 is attached via an adhesive layer, such as glue, such that the first segment layer is opposed to the liquid crystal layer 7. In addition, the second retardation plate RF2 is attached via an adhesive layer, such as glue, such that the second segment layer is opposed to the liquid crystal layer 7.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

FIG. 7B shows the measurement result. It was confirmed that in almost all azimuth directions, the viewing angle with a contrast ratio of 10:1 or more was ±80° or more, and more excellent viewing angle characteristics than in Embodiment 1 were obtained. In addition, the transmittance at 4.2 V was measured, and it was confirmed that a very high transmittance of 5.0% was obtained.

### EMBODIMENT 3

In a liquid crystal display device according to Embodiment 3, an F-based liquid crystal (manufactured by Merck Ltd.) was used as a nematic liquid crystal material with negative dielectric anisotropy for the liquid crystal layer 7. The refractive index anisotropy Δn of the liquid crystal material used in this case is 0.095 (wavelength for measurement=550 nm; in the description below, all refractive indices and phase differences of retardation plates are values measured at wavelength of 550 nm), and the thickness d of the liquid crystal layer 7 is 3.5 μm. Thus, the Δn·d of the liquid crystal layer 7 is 330 nm.

In Embodiment 3, a uniaxial ¼ wavelength plate (in-plane phase difference=140 nm), which is formed of ZEONOR resin (manufactured by Nippon Zeon Co., Ltd.), is used as the first retardation plate RF1 and second retardation plate RF2. A vertical alignment film, which is formed of JALS214-R14 (manufactured by JSR), is provided on the surface (opposed to the polarizer plate) of the film used as the first retardation plate RF1. Subsequently, a nematic liquid crystal polymer (manufactured by Merck Ltd.) is coated. The refractive index anisotropy Δn of this liquid crystal polymer is 0.040, and the thickness d thereof is 1.25 μm. Thus, the normal-directional phase difference of the liquid crystal polymer is 50 nm. This liquid crystal polymer functions as the third retardation plate RF3. Further, the surface of the liquid crystal polymer layer functioning as the third retardation plate RF3 is rubbed, and a discotic liquid crystal polymer (manufactured by Fuji Photo Film Co., Ltd.) is coated. The refractive index anisotropy Δn of this liquid crystal polymer is 0.102, and the thickness d thereof is 0.196 μm. Since the in-plane slow axis and the rubbing direction of this liquid crystal polymer layer intersect at right angles, the in-plane phase difference of the liquid crystal polymer with respect to the rubbing direction is 20 nm. This liquid crystal polymer layer functions as the sixth phase retardation plate RF6.

Similarly, a liquid crystal polymer layer with a normal-directional phase difference of 50 nm is formed on the surface of the film that is used as the second retardation plate RF2. This liquid crystal polymer layer functions as the fourth retardation plate RF4. Further, the surface of the liquid crystal polymer layer functioning as the fourth retardation plate RF4 is rubbed, and a discotic liquid crystal polymer (manufactured by Fuji Photo Film Co., Ltd.) is coated. The refractive index anisotropy Δn of this liquid crystal polymer is 0.102, and the thickness d thereof is 0.196 μm. Since the in-plane slow axis and the rubbing direction of this liquid crystal polymer layer intersect at right angles, the in-plane phase difference of the liquid crystal polymer with respect to the rubbing direction is 20 nm. This liquid crystal polymer layer functions as the seventh phase retardation plate RF7.

On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 2.36 μm, which has a refractive index anisotropy Δn of 0.102 and a helical pitch of 0.9 μm. The coated liquid crystal polymer layer is irradiated with ultraviolet in the state in which the helical axis agrees with the normal direction of the film. This liquid crystal polymer layer functions as the fifth retardation plate RF5. The normal-directional phase difference of the fifth retardation plate RF5, which is thus obtained, is −220 nm.

The first retardation plate RF1 having the functions of the third retardation plate RF3 and sixth retardation plate RF6 is attached via an adhesive layer, such as glue, such that the first retardation plate RF1 is opposed to the liquid crystal layer 7. In addition, a polarizer plate of SRW062A (manufactured by Sumitomo Chemical Co., Ltd.) is attached as the first polarizer plate PL1 via an adhesive layer, such as glue, on the sixth retardation plate RF6. The first polarizer plate PL1 is disposed such that the transmission axis of the first polarizer plate PL1 is parallel to the rubbing direction at the time of forming the sixth retardation plate RF6.

On the other hand, the second retardation plate RF2, which has the functions of the fourth retardation plate RF4, seventh retardation plate RF7 and fifth retardation plate RF5, is attached via an adhesive layer, such as glue, such that the fifth retardation plate RF5 is opposed to the liquid crystal layer 7. In addition, a polarizer plate of SRW062A (manufactured by Sumitomo Chemical Co., Ltd.) is attached as the second polarizer plate PL2 via an adhesive layer, such as glue, on the seventh retardation plate RF7. The second polarizer plate PL2 is disposed such that the transmission axis of the second polarizer plate PL2 is parallel to the rubbing direction at the time of forming the seventh retardation plate RF7.

The angle between the transmission axis of each of the first polarizer plate PL1 and second polarizer plate PL2 and the slow axis of each of the first retardation plate RF1 and second retardation plate RF2 is π/4 (rad). The transmission axis of the first polarizer plate PL1 and the slow axis of the third retardation plate RF3 are parallel. Protrusions 12 and slits 11 are arranged such that the orientation direction of liquid crystal molecules at the time when voltage is applied to the liquid crystal layer 7 is parallel or perpendicular to the transmission axes of the first polarizer plate PL1 and second polarizer plate PL2. The absorption axis of the second polarizer plate PL2 and the absorption axis of the first polarizer plate PL1 are disposed to intersect at right angles with each other. Further, the slow axis of the first retardation plate RF1 and the slow axis of the second retardation plate RF2 are disposed to intersect at right angles with each other.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

FIG. 7C shows the measurement result. It was confirmed that in almost all azimuth directions, the viewing angle with a contrast ratio of 10:1 or more was ±80° or more, and more excellent viewing angle characteristics than in Embodiment 2 were obtained. In addition, the transmittance at 4.2 V was measured, and it was confirmed that a very high transmittance of 5.0% was obtained.

### EMBODIMENT 4

The structure of a liquid crystal display device according to Embodiment 4 is the same as the structure of the liquid crystal display device according to Embodiment 3, except that the fifth retardation plate RF5 is composed of two segments, as shown in FIG. 1C.

Specifically, in Embodiment 4, a liquid crystal polymer layer, which functions as the third retardation plate RF3, is formed on the surface (opposed to the polarizer plate) of the film used as the first retardation plate RF1. On the other hand, the back surface (opposed to the liquid crystal cell C) of the film that is used as the first retardation plate RF1 is rubbed, and the rubbed surface is coated with an ultraviolet cross-linking chiral nematic liquid crystal (manufactured by Merck Ltd.) with a thickness of 1.18 μm, which has a refractive index anisotropy Δn of 0.102 and a helical pitch of 0.9 μm. The coated liquid crystal polymer layer is irradiated with ultraviolet in the state in which the helical axis agrees with the normal direction of the film. This liquid crystal polymer layer functions as a first segment layer of the fifth retardation plate RF5. The normal-directional phase difference of the first segment layer, which is thus obtained, is −110 nm.

Similarly, a liquid crystal polymer layer, which functions as the fourth retardation plate RF4, is formed on the surface of the film used as the second retardation plate RF2. On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 1.18 μm, which has a refractive index anisotropy Δn of 0.102 and a helical pitch of 0.9 μm. The coated liquid crystal polymer layer is irradiated with ultraviolet in the state in which the helical axis agrees with the normal direction of the film. This liquid crystal polymer layer functions as a second segment layer of the fifth retardation plate RF5. The normal-directional phase difference of the second segment layer, which is thus obtained, is −110 nm.

This first retardation plate RF1 is attached via an adhesive layer, such as glue, such that the first segment layer is opposed to the liquid crystal layer 7. In addition, the second retardation plate RF2 is attached via an adhesive layer, such as glue, such that the second segment layer is opposed to the liquid crystal layer 7.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

FIG. 7D shows the measurement result. It was confirmed that in almost all azimuth directions, the viewing angle with a contrast ratio of 10:1 or more was ±90° or more, and more excellent viewing angle characteristics than in Embodiment 3 were obtained. In addition, the transmittance at 4.2 V was measured, and it was confirmed that a very high transmittance of 5.0% was obtained.

### COMPARATIVE EXAMPLE 1

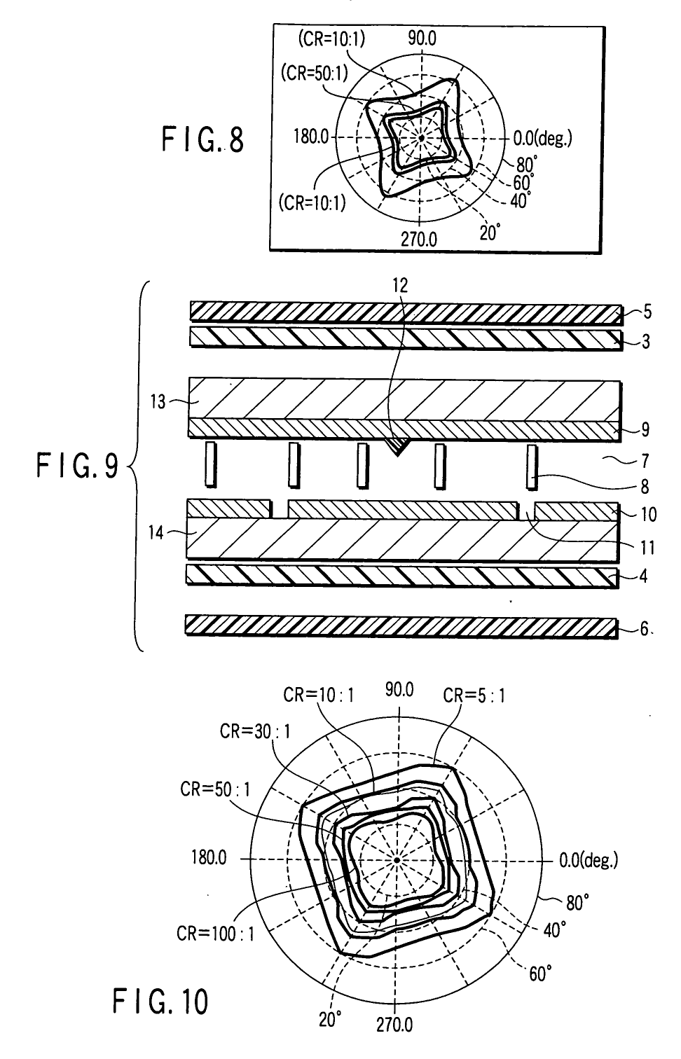

As Comparative Example 1, a circular-polarization-based MVA-mode liquid crystal display device was fabricated by removing the first optical compensation layer OC1, second optical compensation layer OC2 and third optical compensation layer OC3 from the structure shown in FIG. 1A. As regards the other conditions for fabrication, the liquid crystal display device of Comparative Example 1 is fabricated using the same materials and processes as in Embodiment 1. Like Embodiment 1, the viewing angle characteristics of the contrast ratio were evaluated. FIG. 8 shows the measurement result. The viewing angle with a contrast ratio of 10:1 or more was ±60° or more in specific azimuth directions, but was generally about ±40°.

### COMPARATIVE EXAMPLE 2

As is shown in FIG. 9, an MVA-mode liquid crystal display device according to Comparative Example 2 includes retardation plates 3 and 4 and polarizer plates 5 and 6, which are provided on both outside surfaces of the liquid crystal cell. The retardation plate 3, 4 is a uniaxial ¼ wavelength plate having such a refractive index anisotropy as nx>ny=nz. The retardation plate 3, 4 is disposed such that the angle between the slow axis thereof and the transmission axis of the polarizer plate 5, 6 is π/4 (rad).

In the above structure, the paired retardation plates 3 and 4 are configured such that their slow axes intersect at right angles with each other. Accordingly, the retardation plates 3 and 4 function as negative retardation plates and impart a negative phase difference of about −280 nm to light with a wavelength of 550 nm. On the other hand, in order to obtain a phase difference of ½ wavelength by an electric field control, the liquid crystal layer 7 needs to have the value of Δn·d of 300 nm or more, which is obtained by multiplying the refractive index anisotropy Δn of the liquid crystal material by the thickness d of the liquid crystal layer. Consequently, the total phase difference of the liquid crystal display device does not become zero, and the viewing angle characteristics at the black display time deteriorate. In addition, since the uniaxial ¼ wavelength plate is used, a viewing angle dependency occurs in polarization characteristics of circularly polarized light that enters the liquid crystal layer, owing to the viewing angle characteristics of the polarizer plate. In the circular-polarization-based MVA mode with this structure, there is such a problem that the contrast/viewing angle characteristic range is narrow because of lack of means for compensating the viewing angle dependency of circularly polarized light, which enters the liquid crystal layer, or the viewing angle dependency of the phase difference of the liquid crystal layer. As shown in FIG. 10, the viewing angle with a contrast ratio of 10:1 or more is about ±40° in the vertical direction and horizontal direction, and is narrow. Practically tolerable characteristics are not obtained.

### COMPARATIVE EXAMPLE 3

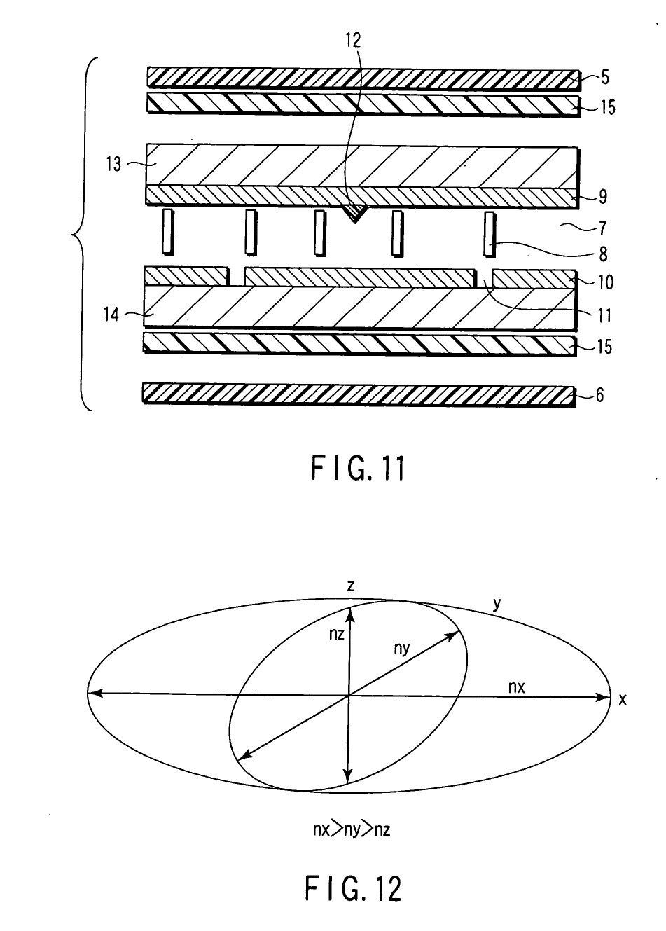

A liquid crystal display device according to Comparative Example 3, as shown in FIG. 11, has a circular-polarization-based MVA mode in which the uniaxial ¼ wavelength plate is replaced with a biaxial ¼ wavelength plate. In this structure, the refractive index anisotropy of the employed ¼ wavelength plate is nx>ny>nz, as shown in FIG. 12. Thus, the in-plane phase difference is ¼ wavelength. If the paired ¼ wavelength plates 15 are disposed such that their slow axes intersect at right angles, they function as negative retardation plates. Thus, if the phase difference value is controlled, the normal-directional phase difference of the liquid crystal layer can be compensated and the viewing angle characteristics are improved.

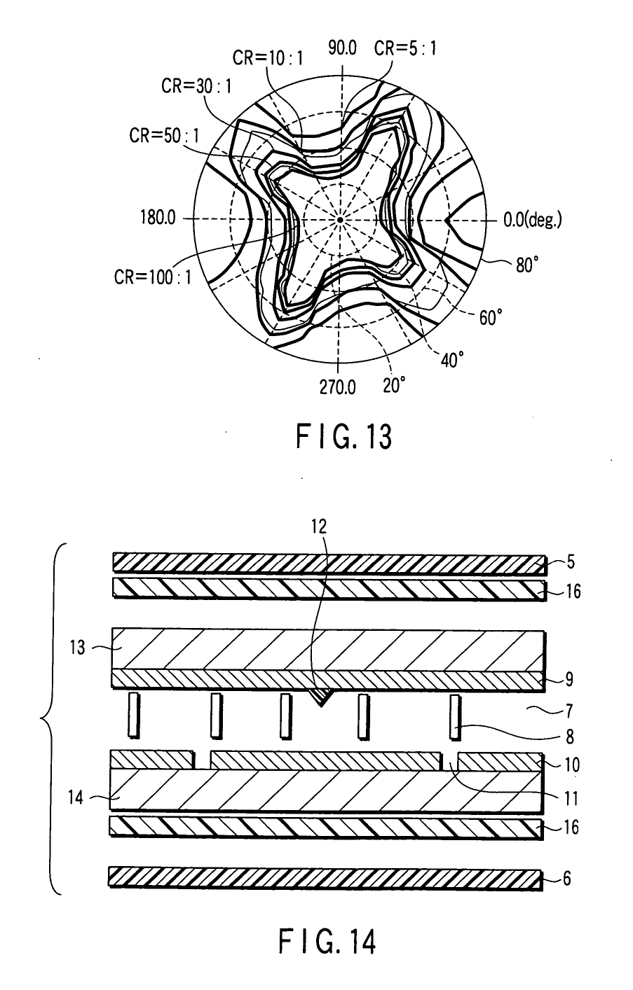

FIG. 13 shows an actual measurement result of isocontrast curves of the liquid crystal display device shown in FIG. 11. Compared to the result shown in FIG. 10, it is understood that the viewing angle is slightly increased and the characteristics are improved. However, the viewing angle with a contrast ratio of 10:1 or more is about ±80° and is wide in the oblique directions, but the viewing angle with a contrast ratio of 10:1 or more is about ±40° in the vertical and horizontal directions, which fails to satisfy practically tolerable viewing angle characteristics. The reason is as follows. The phase difference in the normal direction of the liquid crystal layer is improved to some degree by the above-described biaxial ¼ wavelength plates. An actually usable film, however, is a high-polymer film, and it is difficult to match it with wavelength dispersion of the phase difference of the liquid crystal layer. Furthermore, the film, as a circular polarizer plate, does not have such a structure as to have sufficient viewing angle characteristics, and this leads to the above-mentioned viewing angle characteristics of the contrast ratio.

The paired ¼ wavelength plates 15 have the function of simultaneously realizing the functions of the third optical compensation layer OC3, first retardation plate RF1 and second retardation plate RF2, which are used in the above-described embodiment. If the conditions are so set as to also compensate the normal-directional phase difference of the liquid crystal layer 7, the light emerging from the biaxial ¼ wavelength plate necessarily becomes elliptically polarized light. Thus, the light emerging from the biaxial ¼ wavelength plate becomes polarized light that is polarized in the major-axis direction of the ellipsoid. As a result, transmittance characteristics, which depend on the liquid crystal molecule orientation direction, are obtained, and a sufficient viewing angle compensation effect cannot be obtained depending on directions, as shown in FIG. 13.

### COMPARATIVE EXAMPLE 4

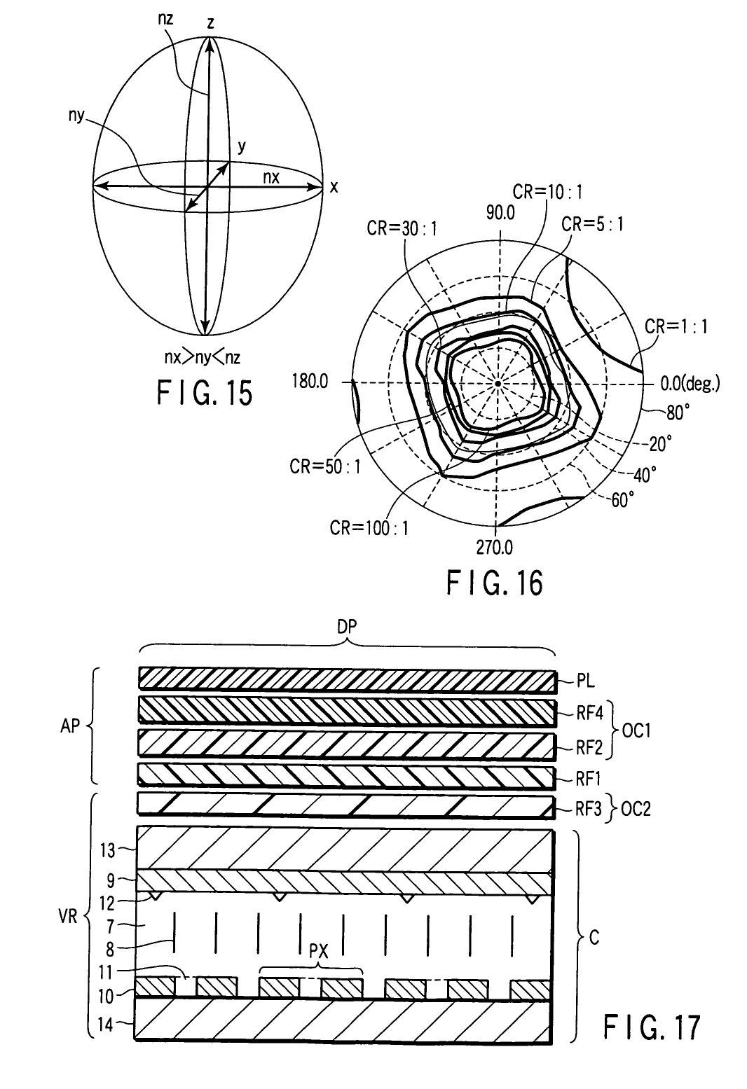

A liquid crystal display device according to Comparative Example 4 shown in FIG. 14 has a circular-polarization-based MVA mode in which the biaxial ¼ wavelength plate 15 is replaced with a biaxial ¼ wavelength plate shown in FIG. 15. In this structure, the refractive index anisotropy of the employed ¼ wavelength plate is nx>ny<nz. Thus, even in the case where nx>nz and the paired wavelength plates 16 are disposed above and below the liquid crystal cell so as to have slow axes perpendicular to each other, the effect of the negative phase difference is weakened, compared to the structure shown in FIG. 9 in which the upper and lower uniaxial ¼ wavelength plates are disposed to be perpendicular to each other. In the case where nx<nz, a positive phase difference occurs. Consequently, the contrast/viewing angle characteristic range becomes narrower than in the structure shown in FIG. 9, unless the refractive index anisotropy Δn of the liquid crystal layer is set to be very small, that is, unless the variation in phase difference of the liquid crystal layer is set below ½ wavelength and the transmittance of the liquid crystal cell becomes insufficient.

FIG. 16 shows an actual measurement result of isocontrast curves of the liquid crystal display device shown in FIG. 14. As shown in FIG. 16, there occurs a region where the contrast ratio is 1:1 or less, and it is understood that the viewing angle characteristic range is narrower than in FIG. 10 or FIG. 13. This is partly because the structure of the polarizer plate, like the structure shown in FIG. 11, is not configured to obtain sufficient viewing angle characteristics as a circular polarizer plate.

Each of the structures shown in FIG. 11 and FIG. 14 uses the biaxial ¼ wavelength plate. The biaxial phase plate is formed by biaxial-drawing a high-polymer film, which leads to an increase in manufacturing cost. In addition, the refractive index is controllable only in a limited range, and it is difficult to realize a desired refractive index ellipsoid. Moreover, the range of selection of material for obtaining biaxiality is narrow, and it is difficult to match the material with the wavelength dispersion characteristic of the refractive index of the liquid crystal.

As has been described above, the present invention provides a novel structure of a liquid crystal display device. This structure aims at preventing a decrease in transmittance, which occurs when liquid crystals are schlieren-oriented or orientated in an unintentional direction in a display mode, such as a vertical alignment mode or a multi-domain vertical alignment mode, in which the phase of incident light is modulated by about ½ wavelength in the liquid crystal layer. This invention can solve such problems that the viewing angle characteristic range is narrow and the manufacturing cost of components that are used is high, in the circular-polarization-based display mode in which circularly polarized light is incident on the liquid crystal layer, in particular, in the circular-polarization-based MVA display mode.

According to the novel structure, not only high transmittance characteristics can be obtained, but also excellent contrast vs. viewing angle characteristics are realized. Moreover, the manufacturing cost is lower than in the circular-polarization-based MVA mode using the viewing angle compensation structure as shown in Comparative Examples 3 and 4.

The present invention is not limited to the above-described embodiments. At the stage of practicing the invention, various modifications and alterations may be made without departing from the spirit of the invention. Structural elements disclosed in the embodiments may properly be combined, and various inventions can be made. For example, some structural elements may be omitted from the embodiments. Moreover, structural elements in different embodiments may properly be combined.

The above-described embodiments are directed to liquid crystal display devices in which a transmissive part is provided in at least a part of the pixel PX of the liquid crystal cell C or in at least a part of the display region DP. The invention, however, is not limited to these embodiments. The same structure as in the present invention is also applicable to, e.g. a transflective liquid crystal display device wherein a reflective layer is provided on at least a part of the pixel PX of the liquid crystal cell C, a partial-reflective liquid crystal display device wherein a reflective layer is provided in at least a part of the display region DP, and a reflective liquid crystal display device wherein a reflective layer is provided on the entire region of all pixels PX.

Specifically, as shown in FIG. 17, a circular-polarization-based MVA-mode liquid crystal display device comprises a circular polarizer/analyzer structure AP and a variable retarder structure VR, which are stacked in the named order. The variable retarder structure VR includes a dot-matrix liquid crystal cell C in which a liquid crystal layer is held between two electrode-equipped substrates. Specifically, this liquid crystal cell C is an MVA mode liquid crystal cell, and a liquid crystal layer 7 is sandwiched between an active matrix substrate 14 and a counter-substrate 13. In the liquid crystal cell C, a display region DP is composed of pixels PX that are arranged in a matrix.

The example shown in FIG. 17 is a reflective liquid crystal display device. A pixel electrode 10, which is disposed in each pixel PX, functions as a reflective layer and is formed of a light-reflective metal material such as aluminum. In the reflective part including the reflective layer, the thickness d of the liquid crystal layer 7 is set at about half the thickness of the transmissive part of the liquid crystal display device according to the above-described embodiments. In the other respects, the liquid crystal cell C has the same structure as shown in FIG. 1A, so a description is omitted here.

The circular polarizer/analyzer structure AP includes a polarizer plate PL and a uniaxial first retardation plate RF1 that is interposed between the polarizer plate PL and liquid crystal cell C. The first retardation plate RF1 has a fast axis and a slow axis in its plane, which are substantially perpendicular to each other, and provides a phase difference of ¼ wavelength between light rays with a predetermined wavelength (e.g. 550 nm), which pass through the fast axis and slow axis. A retardation plate that is applicable to the first retardation plate RF1 should have a refractive index anisotropy (nx>ny=nz) as shown in FIG. 2.

The liquid crystal display device with this structure includes a first optical compensation layer OC1, which is disposed for optical compensation of the circular polarizer/analyzer structure AP between the polarizer plate PL and first retardation plate RF1; and a second optical compensation layer OC2, which is disposed for optical compensation of the variable retarder structure VR between the first retardation plate RF1 and the liquid crystal cell C.

Specifically, the first optical compensation layer OC1 compensates the viewing angle characteristics of the circular polarizer/analyzer structure AP so that emission light from the circular polarizer/analyzer structure AP may become substantially circularly polarized light, regardless of the direction of emission. The first optical compensation layer OC1 includes at least an optically uniaxial second retardation plate (positive C-plate) RF2 which has a refractive index anisotropy of nx≈ny<nz, as shown in FIG. 3A.

The second optical compensation layer OC2 compensates the viewing angle characteristics of the liquid crystal cell C in the variable retarder structure VR (i.e. an optically positive normal-directional phase difference of the liquid crystal layer 7 in the state in which the liquid crystal molecules 8 are aligned substantially vertical to the major surface of the substrate, that is, in the state of black display). The second optical compensation layer OC2 includes an optically uniaxial third retardation plate (negative C-plate) RF3 which has a refractive index anisotropy of nx≈ny>nz, as shown in FIG. 3B.

In the example shown in FIG. 17, the first optical compensation layer OC1 further includes an optically uniaxial fourth retardation plate (negative A-plate) RF4 which has a refractive index anisotropy of nx<ny≈nz, as shown in FIG. 4. The fourth retardation plate RF4 is disposed such that its slow axis is substantially parallel to the transmission axis of the polarizer plate PL. In this example, the fourth retardation plate RF4 is positioned between the polarizer plate PL and second retardation plate RF2. In addition, in the example shown in FIG. 17, the third retardation plate RF3, which constitutes the third optical compensation layer OC3, is disposed between the liquid crystal cell C and the first retardation RF1.

The first retardation plate RF1 in this example can be formed of the same material as the second retardation plate described with reference to FIG. 1A. The second retardation plate RF2 in this example can be formed of the same material as the fourth retardation plate described with reference to FIG. 1A. The third retardation plate RF3 in this example can be formed of the same material as the fifth retardation plate described with reference to FIG. 1A. The fourth retardation plate RF4 in this example can be formed of the same material as the seventh retardation plate described with reference to FIG. 1A.

In the above-described liquid crystal display device, the first optical compensation layer OC1 may be formed of an optical device OD1 in which the total optical function is equivalent to biaxial refractive index anisotropy of nx<ny<nz. For example, a functional layer, which functions as the second retardation plate RF2, and a functional layer, which functions as the fourth retardation plate RF4, are formed on the same plane (e.g. the first retardation plate RF1). Thereby, a single retardation plate, which has substantially the same optical function as the biaxial refractive index anisotropy can be formed. By constructing the first optical compensation layer OC1 as a single unit, the number of components can be reduced, the total layer thickness can be reduced, and the reduction in thickness of the device can advantageously be realized.

The third retardation plate RF3 may be formed on the first retardation plate RF1. Thereby, an optical device, in which the total optical function is equivalent to biaxial refractive index anisotropy of nx>ny>nz, may be formed. For example, by forming a functional layer, which functions as the third retardation plate RF3, on the first retardation plate RF1, it is possible to construct a single retardation plate which has substantially the same optical function as biaxial refractive index anisotropy. In this manner, the combination of the third retardation plate RF3 and first retardation plate RF1 may be formed as a single unit. Thereby, the number of components can be reduced, the total layer thickness can be reduced, and the reduction in thickness of the device can advantageously be realized.

The optimizing condition for the first optical compensation layer OC1 and second optical compensation layer OC2 is the same as in the above-described embodiment. When the normal-directional phase difference of the second retardation plate RF2 is R(1), the normal-directional phase difference of the third retardation plate RF3 is R(2) and the in-plane phase difference of the fourth retardation plate RF4 is R(3), it has been made clear that the optimizing condition, which is to be satisfied, is:
−6/5×R(1)−244≦R(2)≦−6/5×R(1)−172,
and
20≦R(2)≦80, and
−40≦R(3)≦0.

It is also made clear that a more preferable optimizing condition, which is to be satisfied in order to obtain a viewing angle of 60° or more with a contrast ratio of 10:1 or more in the direction of a least viewing angle, is:
−230≦R(1)≦−210, and
40≦R(2)≦60, and
−40≦R(3)≦0.

As described in connection with the prior art, in the liquid crystal display device with the reflective part, too, the viewing-angle characteristics can be improved by using biaxial retardation plates. According to the structure of this embodiment, however, the uniaxial first retardation plate (¼ wavelength plate) RF1 and the second retardation plate RF2, which is included in the first optical compensation layer OC1, are combined. Hence, it becomes possible to provide substantially the same function as the biaxial retardation plate that is capable of improving viewing angle characteristics. Thereby, the viewing angle characteristics can be improved, and the cost can be reduced, compared to the case of using the biaxial retardation plate.

Needless to say, a single cell C may be configured to include both the above-described transmissive part and reflective part.

What is claimed is:

1. A liquid crystal display device which is configured such that a dot-matrix liquid crystal cell, in which a liquid crystal layer is held between two electrode-equipped substrates, is disposed between a first polarizer plate that is situated on a light source side and a second polarizer plate that is situated on an observer side, a first retardation plate is disposed between the first polarizer plate and the liquid crystal cell, and a second retardation plate is disposed between the second polarizer plate and the liquid crystal cell, the liquid crystal display device comprising:
a circular polarizer structure including the first polarizer plate and the first retardation plate;
a variable retarder structure including the liquid crystal cell; and
a circular analyzer structure including the second polarizer plate and the second retardation plate,
wherein the variable retarder structure has an optically positive normal-directional phase difference in a black display state,
each of the first retardation plate and the second retardation plate is a uniaxial ¼ wavelength plate which provides a phase difference of a ¼ wavelength between light rays of predetermined wavelengths that travel along a fast axis and a slow axis thereof,
the circular polarizer structure includes a first optical compensation layer which is disposed for optical compensation of the circular polarizer structure between the first polarizer plate and the first retardation plate, the first optical compensation layer including a uniaxial third retardation plate with a refractive index anisotropy of nx≈ny<nz,
the circular analyzer structure includes a second optical compensation layer which is disposed for optical compensation of the circular analyzer structure between the second polarizer plate and the second retardation plate, the second optical compensation layer including a uniaxial fourth retardation plate with a refractive index anisotropy of nx≈ny<nz, and
the variable retarder structure includes a third optical compensation layer which is disposed for optical compensation of the variable retarder structure between the first retardation plate and the second retardation plate, the third optical compensation layer including a uniaxial fifth retardation plate with a refractive index anisotropy of nx≈ny>nz.

2. The liquid crystal display device according to claim 1, wherein the first optical compensation layer includes a uniaxial sixth retardation plate with a refractive index anisotropy of nx<ny≈nz, a slow axis of the sixth retardation plate being disposed to be substantially parallel to a transmission axis of the first polarizer plate, and
the second optical compensation layer includes a uniaxial seventh retardation plate with a refractive index anisotropy of nx<ny≈nz, a slow axis of the seventh retardation plate being disposed to be substantially parallel to a transmission axis of the second polarizer plate.

3. The liquid crystal display device according to claim 2, wherein the first optical compensation layer is formed of an optical device in which a total optical function is equivalent to a biaxial refractive index anisotropy of nx<ny<nz.

4. The liquid crystal display device according to claim 2, wherein the second optical compensation layer is formed of an optical device in which a total optical function is equivalent to a biaxial refractive index anisotropy of nx<ny<nz.

5. The liquid crystal display device according to claim 1, wherein the fifth retardation plate is formed on one of the first retardation plate and the second retardation plate such that a total optical function is equivalent to a biaxial refractive index anisotropy of nx>ny>nz.

6. The liquid crystal display device according to claim 1, wherein the fifth retardation plate comprises a first segment layer, which is disposed between the first retardation plate and the liquid crystal cell, and a second segment layer, which is disposed between the second retardation plate and the liquid crystal cell.

7. The liquid crystal display device according to claim 6, wherein the first segment layer is formed on the first retardation plate such that a total optical function is equivalent to a biaxial refractive index anisotropy of nx>ny>nz.

8. The liquid crystal display device according to claim 6, wherein the second segment layer is formed on the second retardation plate such that a total optical function is equivalent to a biaxial refractive index anisotropy of nx>ny>nz.

9. The liquid crystal display device according to claim 1, wherein the liquid crystal cell has a vertical alignment mode in which liquid crystal molecules in a pixel are aligned substantially vertical to a major surface of the substrate in a voltage-off state.

10. The liquid crystal display device according to claim 9, wherein the liquid crystal cell has a multi-domain vertical alignment mode in which liquid crystal molecules in the pixel are controlled and oriented in at least two directions in a voltage-on state.

11. The liquid crystal display device according to claim 9, wherein such a domain is formed that an orientation direction of liquid crystal molecules in the pixel in a voltage-on state is substantially parallel to an absorption axis or a transmission axis of the first polarizer plate in at least half an opening region of each pixel.

12. The liquid crystal display device according to claim 10, wherein a protrusion for forming a multi-domain structure is provided within the pixel.

13. The liquid crystal display device according to claim 10, wherein a slit for forming a multi-domain structure is provided in the electrode.

14. The liquid crystal display device according to claim 10, wherein alignment films, which are subjected to an alignment treatment for forming a multi-domain structure, are provided on those surfaces of the two substrates, which sandwich the liquid crystal layer.

15. The liquid crystal display device according to claim 1, wherein the first retardation plate and the second retardation plate are formed of a resin selected from the group consisting of ARTON resin, a polyvinyl alcohol resin, ZEONOR resin, a triacetyl cellulose resin and a denatured polycarbonate resin.

16. The liquid crystal display device according to claim 1, wherein the third retardation plate and the fourth retardation plate are formed of a nematic liquid crystal polymer having a normal-directional optical axis.

17. The liquid crystal display device according to claim 1, wherein the fifth retardation plate is formed of one of a chiral nematic liquid crystal polymer, a cholesteric liquid crystal polymer and a discotic liquid crystal polymer.

18. The liquid crystal display device according to claim 2, wherein the sixth retardation plate and the seventh retardation plate are formed of a discotic liquid crystal polymer having an in-plane optical axis.

19. The liquid crystal display device according to claim 2, wherein when a normal-directional phase difference of each of the third retardation plate and the fourth retardation plate is R(1), a normal-directional phase difference of the fifth retardation plate is R(2) and an in-plane phase difference of each of the sixth retardation plate and the seventh retardation plate is R(3), the following condition is satisfied:
−6/5×R(1)−244≦R(2)≦−6/5×R(1)−172,
and
20≦R(2)≦80, and
−40≦R(3)≦0.

20. The liquid crystal display device according to claim 2, wherein when a normal-directional phase difference of each of the third retardation plate and the fourth retardation plate is R(1), a normal-directional phase difference of the fifth retardation plate is R(2) and an in-plane phase difference of each of the sixth retardation plate and the seventh retardation plate is R(3), the following condition is satisfied:
−230≦R(1)≦−210, and
40≦R(2)≦60, and
−40≦R(3)≦0.

21. The liquid crystal display device according to claim 1, wherein the liquid crystal cell includes a reflective layer on at least a part of the pixel, or in at least a part of the display region.

22. A liquid crystal display device which is configured such that a first retardation plate is disposed between a dot-matrix liquid crystal cell, in which a liquid crystal layer is held between two electrode-equipped substrates and a reflective layer is provided on each of pixels, and a polarizer plate, the liquid crystal display device comprising:
a circular polarizer/analyzer structure including the polarizer plate and the first retardation plate; and
a variable retarder structure including the liquid crystal cell,
wherein the variable retarder structure has an optically positive normal-directional phase difference in a black display state,
the first retardation plate is a uniaxial ¼ wavelength plate which provides a phase difference of a ¼ wavelength between light rays of predetermined wavelengths that travel along a fast axis and a slow axis thereof,
the circular polarizer/analyzer structure includes a first optical compensation layer which is disposed for optical compensation of the circular polarizer/analyzer structure between the polarizer plate and the first retardation plate, the first optical compensation layer including a uniaxial second retardation plate with a refractive index anisotropy of nx≈ny<nz, and
the variable retarder structure includes a second optical compensation layer which is disposed for optical compensation of the variable retarder structure between the first retardation plate and the liquid crystal cell, the second optical compensation layer including a third retardation plate with a refractive index anisotropy of nx≈ny>nz.

23. The liquid crystal display device according to claim 22, wherein the first optical compensation layer includes a uniaxial fourth retardation plate with a refractive index anisotropy of nx<ny≈nz, a slow axis of the fourth retardation plate being disposed to be substantially parallel to a transmission axis of the polarizer plate.

24. The liquid crystal display device according to claim 23, wherein the first optical compensation layer is formed of a single optical device in which a total optical function is equivalent to a biaxial refractive index anisotropy of nx<ny<nz.

25. The liquid crystal display device according to claim 22, wherein the third retardation plate is formed on the first retardation plate such that a total optical function is equivalent to a biaxial refractive index anisotropy of nx>ny>nz.

26. The liquid crystal display device according to claim 22, wherein the liquid crystal cell has a vertical alignment mode in which liquid crystal molecules in the pixel are aligned substantially vertical to a major surface of the substrate in a voltage-off state.

27. The liquid crystal display device according to claim 26, wherein the liquid crystal cell has a multi-domain vertical alignment mode in which liquid crystal molecules in the pixel are controlled and oriented in at least two directions in a voltage-on state.

28. The liquid crystal display device according to claim 26, wherein such a domain is formed that an orientation direction of liquid crystal molecules in the pixel in a voltage-on state is substantially parallel to an absorption axis or a transmission axis of the polarizer plate in at least half an opening region of each pixel.

29. The liquid crystal display device according to claim 27, wherein a protrusion for forming a multi-domain structure is provided within the pixel.

30. The liquid crystal display device according to claim 27, wherein a slit for forming a multi-domain structure is provided in the electrode.

31. The liquid crystal display device according to claim 27, wherein alignment films, which are subjected to an alignment treatment for forming a multi-domain structure, are provided on those surfaces of the two substrates, which sandwich the liquid crystal layer.

32. The liquid crystal display device according to claim 22, wherein the first retardation plate is formed of a resin selected from the group consisting of ARTON resin, a polyvinyl alcohol resin, ZEONOR resin, a triacetyl cellulose resin and a denatured polycarbonate resin.

33. The liquid crystal display device according to claim 22, wherein the second retardation plate is formed of a nematic liquid crystal polymer having a normal-directional optical axis.

34. The liquid crystal display device according to claim 22, wherein the third retardation plate is formed of one of a chiral nematic liquid crystal polymer, a cholesteric liquid crystal polymer and a discotic liquid crystal polymer.

35. The liquid crystal display device according to claim 23, wherein the fourth retardation plate is formed of a discotic liquid crystal polymer having an in-plane optical axis.

36. The liquid crystal display device according to claim 23, wherein when a normal-directional phase difference of the second retardation plate is R(1), a normal-directional phase difference of the third retardation plate is R(2) and an in-plane phase difference of the fourth retardation plate is R(3), the following condition is satisfied:
−6/5×R(1)−244≦R(2)≦−6/5×R(1)−172,
and
20≦R(2)≦80, and
−40≦R(3)≦0.

37. The liquid crystal display device according to claim 23, wherein when a normal-directional phase difference of the second retardation plate is R(1), a normal-directional phase difference of the third retardation plate is R(2) and an in-plane phase difference of the fourth retardation plate is R(3), the following condition is satisfied:
−230≦R(1)≦−210, and
40≦R(2)≦60, and
−40≦R(3)≦0.
